(19) United States
(12) Patent Application Publication
(10) Pub. No.: US 2020/0371985 A1
(43) Pub. Date: Nov. 26, 2020

(54) AUTOMATED USB DEVICE SELECTION FOR PC-BASED VIDEO CONFERENCING

(71) Applicant: LEGRAND AV Inc., Eden Prairie, MN (US)

(72) Inventor: Darrin Thurston, Eden Prairie, MN (US)

(73) Assignee: LEGRAND AV Inc., Eden Prairie, MN (US)

(21) Appl. No.: 16/766,210

(22) PCT Filed: Nov. 21, 2018
(86) PCT No.: PCT/US2018/062261

§ 371 Date: May 21, 2020

Related U.S. Application Data
(60) Provisional application No. 62/589,333, filed on Nov. 21, 2017.

(51) Int. Cl. G06F 13/42; H04N 7/14; H04L 12/18

(52) U.S. Cl. CPC G06F 13/4282; H04N 7/142; G06F 2213/0042; H04L 12/1822; H04N 7/147

(57) ABSTRACT

Systems and methods for automatically switching hardware device settings in a video conferencing system including monitoring for connectivity of an external hardware device, prompting a user to accept the use of the connected external hardware device, when the prompt is accepted by the user, storing information about a default hardware device, and replacing the default hardware device with the connected external hardware device.

### RELATED APPLICATIONS

This application claims the priority of U.S. Provisional Patent Application No. 62/589,333, filed Nov. 21, 2017, said application being hereby fully incorporated herein by reference.

### TECHNICAL FIELD

The present invention relates to methods, systems, and devices for auto-detection of devices, more particularly auto-detection and of external devices.

### BACKGROUND

Video conferencing has become a significant and frequently-used tool in today's workplace because it provides the ability to have virtual face-to-face meetings with one or more people that are not in the same location. Its growing popularity is due in no small part to the improvements made in video conferencing technology. For example, video conferencing used to require an elaborate and expensive video conferencing setup which limited video conferencing to businesses capable of having a limited number of dedicated video conferencing rooms. Today, users can participate in a video conference using Unified Communication (UC) video conferencing applications in a video conference room having separate audio and video devices that are configured to capture the entire meeting room.

However, in a Bring Your Own Device (BYOD) application where an end-user is using Unified Communication (UC) softclients such as Skype, WebEx, Google Hangouts, etc. within a meeting room, the user is required to select the desired camera and audio device within the UC application. This requirement for an end-user to change USB devices adds user complexity. A user must manually switch their video device and/or audio device every time they use a non-default hardware device.

Therefore, there is a need for systems and methods to automate the configuration process in video conferencing systems using BYOD applications.

### SUMMARY

In an embodiment, a device selection system for switching device settings for a default hardware device having a configuration of default hardware device settings includes a computing platform with computing hardware of at least one processor and a memory operably coupled to the at least one processor and configured to store instructions invoked by the at least one processor, and an operating system implemented on the computing hardware. The operating system includes preferred device settings initially set to the default hardware device settings; instructions that, when executed on the computing platform, cause the computing platform to implement a detection engine configured to monitor for presentation of an external hardware device into the system. The external hardware device can have a predetermined configuration of external hardware device settings, and a hardware configuration engine configured to automatically update the preferred device settings with the external hardware device settings.

In another embodiment, a method of automatically switching hardware device settings in a video conferencing system is disclosed, wherein the video conferencing system includes a computing platform including computing hardware of at least one processor and a memory operably coupled to the at least one processor and configured to store instructions invoked by the at least one processor, and an operating system implemented on the computing hardware. The operating system can include preferred device settings initially set to a predetermined configuration of default hardware device settings. The method includes monitoring for connection of an external hardware device into the video conferencing system, the external hardware device having a predetermined configuration of external hardware device settings; prompting a user to accept the external hardware device; and when the external hardware device is accepted by the user, automatically updating the preferred device settings with the external hardware device settings.

In an embodiment, a hardware device includes a processor and a memory operably coupled to the at least one processor; and a functional element configured to provide input or output to a computing platform. The computing platform can include computing hardware of at least one computing processor and a computing memory operably coupled to the at least one computing processor, and an operating system implemented on the computing hardware, wherein the operating system includes preferred device settings initially set to a predetermined configuration of default hardware device settings, and instructions that, when executed on the processor, cause the processor to implement a hardware configuration engine configured to: prompt the computing platform to accept the hardware device when the hardware device is operably coupled to the computing platform, and automatically update the preferred device settings in the operating system with external hardware device settings specific to the functional element when the hardware device is accepted by the user.

In a feature and advantage of embodiments, an automated device selection system identifies and implements approved video conferencing devices for use in video conferencing applications without the user having to manually access the settings section of the video conferencing applications. The automated device selection system is configured to switch the preferred or default video conferencing device(s) to the newly connected video conferencing device(s).

An example of this process begins with initiation of an application program, which, in this example, also initiates a detection cycle where a detection engine monitors for external device connectivity. In embodiments, the detection engine can continuously or periodically monitor for external device connectivity. Once an external device is detected, the detection engine filters for external device descriptors, which can identify the particular external device as a suitable video conferencing device. If the descriptors of the external device match a predetermined descriptor profile, the detection engine prompts the user to accept or decline the external device as the temporarily preferred video conferencing device. If the user declines, the detection engine returns to the detection cycle but no longer prompts the user to accept or decline the user-declined external device. In some embodiments, a period of time can lapse before detection engine is allowed to prompt the user to accept or decline a previously declined external device.

If the user accepts the external device, the detection engine updates the operating system and/or the application program to set the external device as the operating video conferencing device for the duration of the video conference session. The detection engine then monitors the external device connectivity for disconnection. If the external device becomes disconnected, the detection engine updates the operating system and/or the application program to the default device, which may be integrated laptop audio/video devices in some examples, to the primary video conferencing device status. The detection device then returns to its original state of monitoring for external device connectivity.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIGS. 1A-1B are block diagrams of an automated device selection system, according embodiments.

FIG. 2 is a flowchart of a method for installation and operation of a detection engine, according to an embodiment.

FIG. 3 is a block diagram of an automated device selection system, according to an embodiment.

FIG. 4 is a flowchart of a method for automated device configuration, according to an embodiment.

FIG. 5 is a flowchart of a method for automated device configuration, according to an embodiment.

FIG. 6 is a flowchart of a method for automated device configuration, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

As will be described, embodiments of an automated device selection system and/or its components or subsystems can include computing devices, microprocessors, modules and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

In embodiments, the system or components thereof can comprise or include various modules or engines, each of which is constructed, programmed, configured, or otherwise adapted, to autonomously carry out a function or set of functions. The term “engine” as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

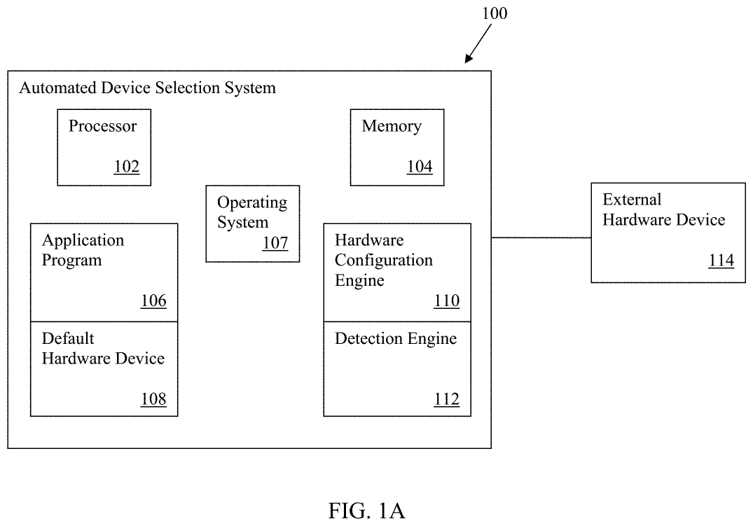

Referring to FIG. 1A, a block diagram of an automated device selection system 100 is depicted, according to an embodiment. As depicted, automated device selection system 100 generally includes a processor 102 and an operably coupled memory 104. In certain embodiments, automated device selection system 100 can comprise a personal computer for a video conferencing room.

Automated device selection system 100 generally comprises an application program 106, an operating system 107, a default hardware device 108, a hardware configuration engine 110, and a detection engine 112 operating in combination or with processor 102 and memory 104.

Application program 106 is configured to enable users at different locations to communicate visually, audibly, or both using a computer. For example, application program 106 can comprise a soft-client such as SKYPE, Google Hangouts®, WebEx®, etc. Application program 106 can be stored on memory 104 and can be executed on operating system 107. Application program 106 can utilize default hardware device 108. In an embodiment, default hardware device 108 is set as the default audio and video devices for application program 106 and operating system 107. In other words, default hardware device(s) 108 are the default audio and video devices to be used for video conferencing.

Operating system 107 is configured to support a computer's basic functions and provide a platform for application software to access and operate the hardware and other functions of automated device selection system 100. Examples of operating system 107 are Microsoft Windows®, MacOS®, Linux®, Chrome®, etc.

Default hardware device 108 is configured to provide audio to and from the user, such as a microphone and speaker system embedded in the housing of a computer. In embodiments, default hardware device 108 can also be configured to capture video, such as a camera embedded in the housing of a computer. In embodiments, default hardware device 108 can comprise both audio and video hardware not necessarily embedded within the housing of a personal computer, but configured to operate with the personal computer by default.

Hardware configuration engine 110 is configured to update hardware settings on operating system 107, application programs 106, or both. In an embodiment, hardware configuration engine 110 is also stored on memory 104 and can be executed on operating system 107 by processor 102. In embodiments, hardware configuration engine 110 is configured to receive external device information from detection engine 112.

Detection engine 112 is configured to monitor for external device connectivity. In an embodiment, detection engine 112 can be stored on memory 104 and can be executed on operating system 107 by processor 102. Detection engine 112 can continuously or periodically monitor for external device connectivity. Detection engine 112 is configured to monitor the system bus for external device activity. For example, detection engine 112 can monitor for USB activity in the case of USB external devices. Detection engine 112 can monitor for other protocols and hardware connectivity, as described herein.

As depicted in FIG. 1A, automated device selection system 100 can further comprise external hardware device 114. External hardware device 114 can be communicatively coupled to automated device selection system 100. In embodiments, external hardware device 114 can be mechanically and communicatively coupled by, for example, insertion of a USB device into a USB port of the personal computer of system 100. In other embodiments, external hardware devices 114 can be communicatively coupled to automated device selection system 100 via USB, HDMI™, or other suitable hard-wired connection, or wirelessly via WIFI or Bluetooth™.

In such an embodiment, detection engine 112 monitors for external hardware device 114 to be communicatively coupled to automated device selection system 100. Detection engine 112 reports information regarding external hardware device 114 connectivity to hardware configuration engine 110. Hardware configuration engine 110 uses external hardware device 114 connectivity information to set audio and video device settings on application program 106, operating system 107, or both.

For the purposes of this embodiment, default hardware devices 108 are audio and video devices that are previously configured and installed with system 100. External hardware devices 114, on the other hand, are audio and video devices that are not considered default audio and video devices by the user. For example, the integrated microphone(s), speaker(s) and camera(s) of a user's laptop could be considered default hardware devices 108. Accordingly, auxiliary microphone(s), speaker(s) and camera(s) present in a conference or meeting room that the user can connect to or brings to the meeting room can be considered external hardware devices 114.

Referring now to FIG. 1B, another block diagram of automated device selection system 100 including external hardware device 114, is depicted according an embodiments. As depicted, external hardware device 114 generally comprises identifying descriptors 116 and functional component 118.

Descriptors 116 can include information that describe the kind, type, model, etc. defining functional component 118 of external hardware device 114. For example, descriptors 116 can be a combination of one or more type of product identification (PID), manufacturer identification (manufacturer ID), and device type. Product identification (PID) can include information regarding product-specific identifier, such as a model number, serial number, etc. Manufacturer ID can include information regarding the manufacturer's name, identifier, or other sourcing information, such as batch and run number. Device type can include information regarding the endpoint defining the type of device, such as USB, Wi-Fi, Bluetooth, etc. Further, descriptors 116 are readable by detection engine 112 or other component of automated device selection system 100 via communicative connection.

Functional component 118 is the functional hardware component of external hardware device 114, such as the physical microphone, speaker, or camera.

Referring to both FIGS. 1A and 1B, automated device selection system 100 (in particular, detection engine 112) continuously or periodically checks for coupling of external hardware devices 114 to system 100. Once detection engine 112 determines that external hardware device 114 has been connected to the system, detection engine 112 reads descriptors 116 on external hardware device 114. In an embodiment, detection engine 112 filters for descriptors 116 such as a product identification number, manufacturer identification, device type. In an embodiment, detection engine 112 communicates descriptors 116 to hardware configuration engine 110. Hardware configuration engine 110 then determines whether external hardware device 114 can be utilized for video conferencing or ignored.

External hardware devices 114 are ignored if hardware configuration engine 110 determines that functional component 118 is not suitable for video conferencing. In other words, if detection engine 112 reads a descriptor 116 identifying an external hard drive via USB, hardware configuration engine 110 determines that the external hard drive connected via USB is not an appropriate external hardware device 114 for use in video conferencing. Hardware configuration engine 10 will then ignore that external hardware device 114 for the purposes of video conferencing.

On the other hand, if detection engine 112 reads a descriptor 116 for a video conferencing identifying a pan-tilt-zoom camera via USB, hardware configuration engine 110 determines that the pan-tilt-zoom camera connected via USB is an appropriate external hardware device 114 for use in video conferencing. Hardware configuration engine 110 will then execute automatic device selection as is discussed below. Further, descriptors 116 allows hardware configuration engine 110 to decipher between external hardware device 114 functions. In other words, descriptors 116 allows hardware configuration engine 110 to identify whether external hardware device 114 is an audio device, video device, or a device that performs other video conferencing functions.

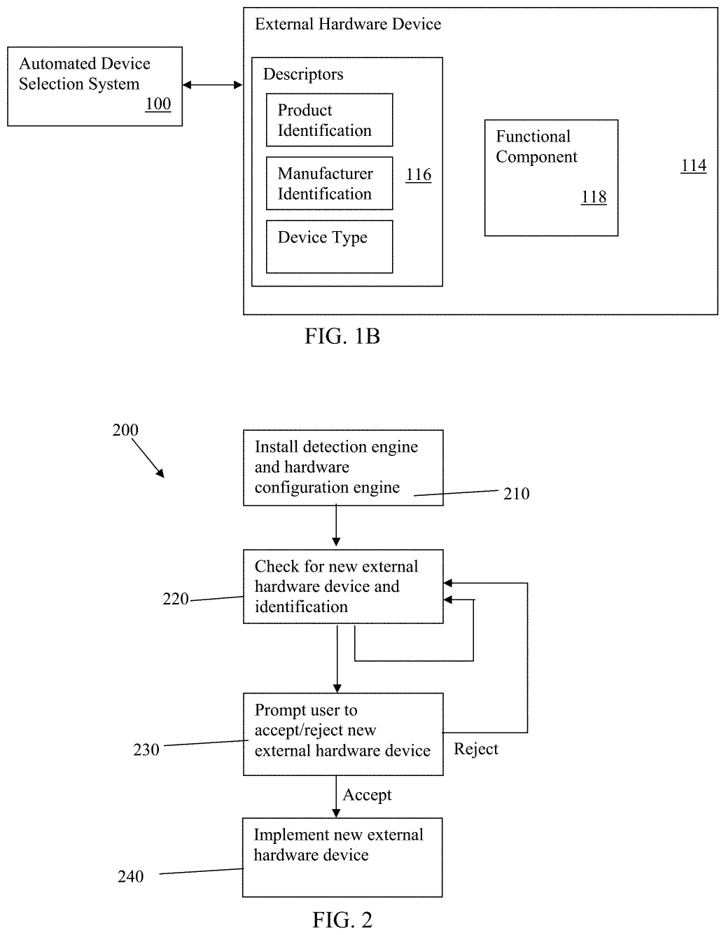

Referring to FIG. 2, flowchart of a method 200 for installation and operation of a detection engine is depicted, according to an embodiment. In an embodiment, FIG. 2 illustrates a process for installation and operation of detection engine 112 and hardware configuration engine 110.

At 210, a detection engine and a hardware configuration engine, such as detection engine 112 and hardware configuration engine 110, is installed onto the automated device selection system 100 platform. In embodiments, automated device selection system 100 can comprise a personal computer having the components discussed in FIG. 1A. In embodiments, detection engine 112 and hardware configuration engine 110 are installed onto a PC controlling a video conferencing room. Installation (or setup) of a computer program (including device drivers and plug-ins, where applicable), includes the act of making detection engine 112 and hardware configuration engine 110 ready for execution.

At 220, an initial operating phase for detection engine 112 is entered. In an embodiment at 220, detection engine 112 continuously or periodically checks for newly connected external hardware devices 114. Further, 220 can include an identifying sub-step where detection engine 112 reads and filters descriptors 116 of external hardware device 114, as previously discussed. In an embodiment, filtering descriptors can include validating the hardware device as the desired USB camera and USB audio device. At 220, detection engine 112 can continuously run during video conferencing setup, or can run continuously while application program 106 is operating or during any other operational period.

If hardware configuration engine 110 determines that external hardware device 114 is appropriate for video conferencing, a prompt to the user is initiated at 230. The prompt can request the user to either accept new external hardware device 114 for video conferencing (and thus change device settings within the operating system and/or application) or continue using default hardware devices, such as default hardware device 108 and reject new external hardware device 114. If external hardware device 114 is selected over default hardware device 108, hardware configuration engine 110 configures the operating system and/or application program for external hardware device 114 at 240. If, however, the prompt is rejected, method 200 returns to 220.

At 240, hardware configuration engine 110 is configured to perform at least two operations, in embodiments. In an initial operation, default hardware device 108 information is stored on memory 104 or elsewhere within system 100 or external to system 100 (but still accessible by system 100 should external hardware device 114 be removed). Further, hardware configuration engine 110 is configured to set external hardware device 114 as the audio or visual device to be used during video conferencing.

In an embodiment, upon automatic device selection such as in FIGS. 1A-2, particular user preferences can be transmitted to external hardware device 114 for pre-configuration. For example, particular user preference can include audio levels of USB loudspeakers and microphones, camera position (field of view) and color settings, and device analytics (when the device was used, how the device was used, etc).

In another embodiment, a priority scheme can be implemented. The priority scheme can set user preferences when multiple USB endpoints of the same device are detected. For example, when two external cameras, such as a RoboSHOT camera and a DocCam are introduced into system 100, priority of one of the particular cameras can be set. In an embodiment, hardware configuration engine 110 can be preconfigured with such preferences. In other embodiments, a user can input such preferences. Accordingly, hardware configuration engine 110 can enable a device that is preferred over another device, and correspondingly disable a device that is not preferred. In embodiments, both devices can be enabled, but for different applications. For example, the RoboSHOT can be set to the preferred device (with appropriate operating system settings) for Skype, and the DocCam can beset to the preferred device (with appropriate operating system settings) for WebEx.

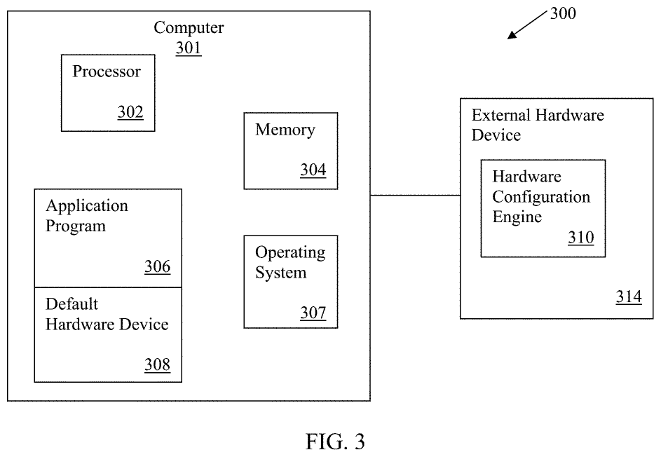

Referring to FIG. 3, a block diagram of an automated device selection system is depicted, according to an embodiment. In this embodiment, automated device selection system 300 comprises a computer 301 including a processor 302, memory 304, application program 306, default hardware device 308, and operating system 307. Processor 302, memory 304, application program 306, default hardware device 308, and operating system 307 are substantially similar to processor 102, memory 104, application program 106, default hardware device 108, and operating system 107 of FIG. 1A, respectively. However, in the embodiment depicted in FIG. 3, an external hardware device 314 itself comprises a hardware configuration engine 310. When external hardware device 314 is connected to the computer 301, hardware configuration engine 310 is configured to communicate with application program 306, operating system 307, or both to configure the computer 301 for application program 306 operation with external hardware device 314.

In use, external hardware device 314 can be connected to computer 301. Once connected, hardware configuration engine 310 sends instruction to application program 306, operating system 307, or both to perform a set of operations. One operation includes hardware configuration engine 310 sending a prompt to the user to accept or decline the use of external hardware device 314. If the user accepts external hardware device 314 instead of default hardware device 308, hardware configuration engine 310 sets external hardware device 314 as the primary audio or video device to be used during video conferencing. In another operation, hardware configuration engine 310 sends a request to store default hardware device 308 information in memory 304.

The request to store default hardware device 308 information in memory 304 also includes an instruction to automatically restore default hardware device 308 as the system's default audio or video device when external hardware device 314 is disconnected. For example, a temporary script or temporary executable can be stored on memory 304 to be automatically run once external hardware device 314 is disconnected. In embodiments, upon disconnection, external hardware device 314 can send a final message to operating system 307 to run the temporary script or temporary executable restoring default hardware device 308. In other embodiments, the temporary script or temporary executable restoring default hardware device 308 can be executed by operating system 307 as a cleanup action for the particular external hardware device 314.

Notably, the embodiment depicted in FIG. 3 does not require a detection engine because hardware configuration engine 310 is located on external hardware device 314, and once connected, hardware configuration engine 310 is configured to prompt the user and configure computer 301 for operation with external hardware device 310. In other words, the embodiment depicted in FIG. 3 is self detecting. In embodiments, an external hardware device including a hardware configuration engine is beneficial because it can potentially require less space on computer 301 and is self-contained such that software does not need to be separately installed on computer 301.

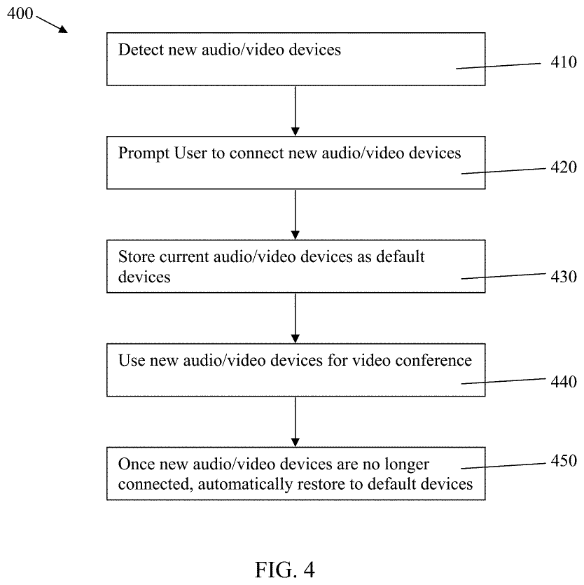

Referring to FIG. 4, a flowchart of a method 400 for automated device configuration is depicted, according to an embodiment. At 410, a new external hardware device(s) are detected. As described above, external hardware device are audio or video devices that have been connected to the user's computer using a suitable communicative connection, such as USB. At 420, the user is prompted to choose whether or not the connected external hardware device should be selected instead of a default hardware device. If external hardware devices are chosen, at 430, a default save operation is initiated. The save operation of 430 saves connectivity information about the default hardware device to memory. At 440, the external hardware device is used during video conferencing instead of the default hardware device. At 450, after video conferencing is completed (or the suitable application program has run) the external hardware device is disconnected from the user's computer. Also at 450, default hardware devices are automatically restored using connectivity information retrieved from the save operation of 430.

In embodiments, method 400 can be implemented for a single external hardware device, as described. In other embodiments, method 400 can accommodate multiple external hardware devices. For example, an external microphone can be connected along with an external video camera (without microphone capability). In embodiments, method 400 can be executed multiple times according to the number of external hardware devices detected. In other embodiments, if multiple external hardware devices are connected at the same time (or relatively close in time to each other), method 400 can detect multiple devices at 410. Typically, a user will connect all of his hardware around the same time in order to get ready for the conference.

For example, at 410, a predetermined pause can be added to allow for additional checking for external devices that might be connected. The predetermined pause timing can allow for a loop to continue checking for operable coupling of external devices. At 420, the user can be presented with multiple new devices for acceptance or rejection. For example, a prompt can have separate lines or entries for the external microphone and the external video camera. The user can select one or the other (or both) for acceptance. At 440, both external hardware devices can be used during video conferencing instead of the default hardware device(s).

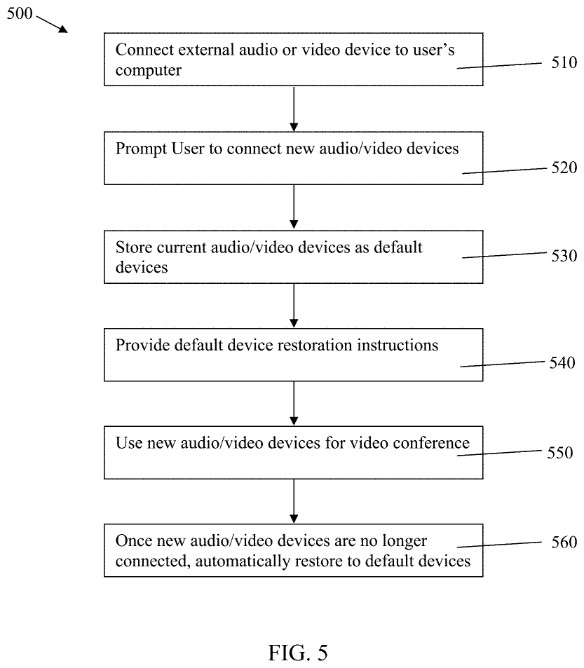

Referring to FIG. 5, a flowchart of a method 500 for automated device configuration is depicted, according to an embodiment. Method 500 can implement, for example, automated device selection system 300 of FIG. 3.

At 510, new external hardware device 314 is connected to the user's computer. At 520, hardware configuration engine 310 prompts the user to choose whether or not external hardware devices 314 should be selected in lieu of default hardware device 308. If external hardware device 314 is chosen by the user, at 530, a default save operation is initiated. The save operation of 530 saves connectivity information about default hardware devices 308 to memory 304. At 540, hardware configuration engine 310 provides instructions to application program 306 and/or operating system 307 to restore default device operation upon disconnection of external hardware device 314 (such as the temporary file or final message described in FIG. 3). At 550, external hardware device 314 is used during video conferencing instead of default hardware devices 308. At 560, external hardware device 314 is disconnected from computer 301. Also at 560, default hardware device 308 is automatically restored according to 540 instructions and using connectivity information retrieved from save operation at 530.

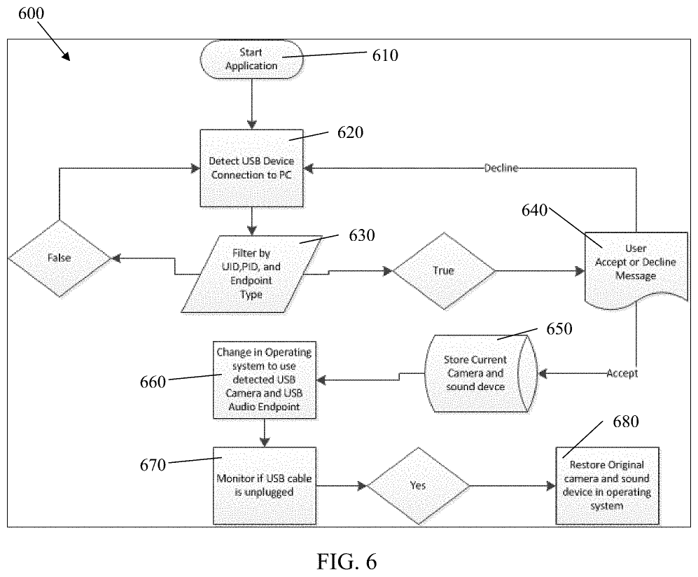

Referring to FIG. 6, a flowchart of a method 600 for automated device configuration is depicted, according to an embodiment. Reference is again made to FIGS. 1A-1B for context. Method 600 begins at 610 with installation and execution a detection engine, such as detection engine 112. The detection cycle, at 620, is automatically entered similar to previously discussed 220 of FIG. 2. Once an external hardware device such as external hardware device 114 is detected, detection engine 112 filters descriptors 116 at 630. Detection engine 112, at 630, compares descriptors 116 with a predetermined profile of acceptable descriptors 16. If descriptors 116 of external hardware device 114 complies with a predetermined profile of acceptable descriptors 116, hardware configuration engine 110 prompts the user to accept or decline external hardware device 114 at 640. If the user declines, detection engine 112 returns to the detection cycle of 620 but no longer prompts the user to acceptor decline that particular external hardware device 114. In an embodiment, a predetermined period of time can lapse before detection engine 112 is allowed to prompt the user to accept or decline a previously declined external hardware device 114.

If the user accepts external hardware device 114, hardware configuration engine 110 instructs a save operation at 650 to save configuration information about default hardware device 108 (or the active hardware device). At 660, once the user accepts external hardware device 114, hardware configuration engine 110 sets external hardware device 114 as the audio or video device to be used for video conferencing with the application program such as application program 106. At 670, detection engine 112 continuously or periodically monitors for external hardware device connectivity. If external hardware device 114 is disconnected, hardware configuration engine 110 returns default hardware device 108 to the primary video conferencing device status at 680 by updating the operating system with the previously-saved configuration information about default hardware device 108 (or the active hardware device). In an embodiment, detection device 112 can then return to monitoring whether or not an external hardware device 114 is connected to the user's computer at 620 (not shown in FIG. 6).

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A device selection system for switching device settings for a default hardware device having a predetermined configuration of default hardware device settings, the system comprising:
a computing platform including computing hardware of at least one processor and a memory operably coupled to the at least one processor and configured to store instructions invoked by the at least one processor, and an operating system implemented on the computing hardware, the operating system including preferred device settings initially set to the default hardware device settings;
instructions that, when executed on the computing platform, cause the computing platform to implement:
a detection engine configured to monitor for presentation of an external hardware device into the system, the external hardware device having a predetermined configuration of external hardware device settings, and
a hardware configuration engine configured to automatically update the preferred device settings with the external hardware device settings.

2. The device selection system of claim 1, wherein the computing platform further comprises a software application implemented on the computing hardware, the software application having software application settings, and wherein the detection engine is further configured to update the software application settings with the external hardware device settings.

3. The device selection system of claim 1, wherein the detection engine is further configured to monitor for removal of the external hardware device from the system, and wherein the hardware configuration engine is further configured to automatically restore the preferred device settings to the default hardware device settings.

4. The device selection system of claim 1, wherein the detection engine is further configured to periodically or continuously monitor for presentation of the external hardware device into the system.

5. The device selection system of claim 1, wherein the detection engine is further configured to read a plurality of descriptors from the external hardware device and compare the plurality of descriptors against a predetermined descriptor profile.

6. The device selection system of claim 5, wherein the plurality of descriptors comprises USB product ID (PID), USB manufacturer ID (UID), and USB device type.

7. The device selection system of claim 5, wherein the detection engine is further configured to prompt a user to accept the update to the preferred device settings when the plurality of descriptors matches the predetermined descriptor profile.

8. The device selection system of claim 1, wherein updating the preferred device settings with the external hardware device settings comprises storing the external hardware device settings in the memory.

9. The device selection system of claim 1, wherein the external hardware device is a USB camera.

10. A method of automatically switching hardware device settings in a video conferencing system, the video conferencing system comprising a computing platform including computing hardware of at least one processor and a memory operably coupled to the at least one processor and configured to store instructions invoked by the at least one processor, and an operating system implemented on the computing hardware, the operating system including preferred device settings initially set to a unique configuration of default hardware device settings, the method comprising:
monitoring for connection of an external hardware device into the video conferencing system, the external hardware device having a unique configuration of external hardware device settings;
prompting a user to accept the external hardware device; and
when the external hardware device is accepted by the user, automatically updating the preferred device settings with the external hardware device settings.

11. The method of automatically switching hardware device settings of claim 10, wherein the computing platform further comprises a software application implemented on the computing hardware, the software application having software application settings, the method further comprising:
updating the software application settings with the external hardware device settings.

12. The method of automatically switching hardware device settings of claim 10, further comprising:
monitoring for disconnection of the external hardware device from the video conferencing system; and
automatically restoring the preferred device settings to the default hardware device settings.

13. The method of automatically switching hardware device settings of claim 10, wherein monitoring for connection of the external hardware device into the video conferencing system comprises periodically or continuously monitoring.

14. The method of automatically switching hardware device settings of claim 10, further comprising:
reading a plurality of descriptors from the external hardware device; and
comparing the plurality of descriptors against a predetermined descriptor profile.

15. The method of automatically switching hardware device settings of claim 14, wherein the plurality of descriptors comprises USB product ID (PID), USB manufacturer ID (UID), and USB device type.

16. The method of automatically switching hardware device settings of claim 10, wherein updating the preferred device settings with the external hardware device settings comprises storing the external hardware device settings in the memory.

17. The method of automatically switching hardware device settings of claim 10, wherein the external hardware device is a USB camera.

18. A hardware device comprising:
a processor and a memory operably coupled to the at least one processor;
a functional element configured to provide input or output to a computing platform, the computing platform including computing hardware of at least one computing processor and a computing memory operably coupled to the at least one computing processor, and an operating system implemented on the computing hardware, the operating system including preferred device settings initially set to a predetermined configuration of default hardware device settings; and
instructions that, when executed on the processor, cause the processor to implement:
a hardware configuration engine configured to:
prompt the computing platform to accept the hardware device when the hardware device is operably coupled to the computing platform, and
automatically update the preferred device settings in the operating system with external hardware device settings specific to the functional element when the hardware device is accepted by the user.

19. The hardware device of claim 18, wherein the hardware configuration engine is further configured to copy a temporary script on the computing platform, the temporary script configured to restore the preferred device settings to the default hardware device settings.

20. The hardware device of claim 19, wherein the hardware configuration engine is further configured to transmit a message to the computing platform to execute the temporary script upon decoupling of the hardware device from the computing platform.
